(19) United States
(12) Patent Application Publication
(10) Pub. No.: US 2012/0279794 A1
(43) Pub. Date: Nov. 8, 2012

(54) Vehicle Controlled Automatic Seat Belt

(76) Inventors: Joshua Jeffrey Clayton, Hughson, CA (US); Jason Braley, Denair, CA (US)

(21) Appl. No.: 13/102,997

(22) Filed: May 6, 2011

(51) Int. Cl. B60R 22/02; G06F 19/00; B60R 22/00

(52) U.S. Cl. 180/269; 297/468; 701/45

(57) ABSTRACT

An automatic vehicle safety belt release system is disclosed having a seat belt, control unit, and power source, connected and operated by the vehicles transmission. The releasing system is incorporated with and will work concurrently with a manual vehicle safety release system. The system is automatically controlled by the vehicles transmission and designed so that when the transmission is put in a specified position an electric signal will be sent to a control unit that is connected to a power source which will send an electric signal to a specified vehicle safety belt latch which will automatically release the specified safety belt through an electronically operated mechanism in the seat belt.

### BACKGROUND OF THE INVENTION

1. Field

The invention relates to an automatic vehicle safety belt release system that is automatically controlled and operated by the vehicles transmission.

2. Prior Art

In all vehicles manufactured in the United States today, including emergency operation vehicles, seat belt units are installed and used. These seat belts consist of two parts one of which is a latching mechanism connected to the seat or vehicle, the other is a latching tongue designed to be attached and locked into the latching mechanism, to secure the person using the seat belt to the seat and vehicle when secured together.

Drivers and passengers of emergency operation vehicles are often involved in life threatening situations where a matter of milliseconds can mean the difference between life and death decisions. These situations include but are not limited to high-speed vehicle pursuits, ambushes, accidents, felony vehicle stops, and many other situations where time is a crucial factor. An issue that has arisen when attempting to exit a vehicle quickly in an above referenced situation is the hassle of manually releasing a seat belt in order to exit the vehicle and address the situation. In these extreme situations due to physiological, mental, and physical stress fine motor skills are lost and performing simple tasks become increasingly difficult. This leads to dangerous situations for the driver or passenger of the emergency vehicle, the victim, the suspect, and any civilians in the area. An unfortunate consequence of this is that the drivers and passengers of emergency vehicles often do not always wear their seat belts so that in an unforeseen future situation they will be able to exit the vehicle as quickly as possible. This causes a dangerous situation for the person not wearing their seat belt in the fact they are not utilizing the safety of the seat belt in the event they are involved in a vehicle accident.

Many law enforcement agencies, fire departments, and other providers of emergency vehicle services have and enforce policies in which they require drivers and passengers in these vehicles to wear their seat belts at all times when operating these vehicles. In addition to the danger drivers and passengers of the emergency vehicle face when not wearing their seat belt, they also are subject to civil and professional liabilities by not wearing their seat belts.

Specifically in the field of law enforcement it has become a common problem that when an officer conducts a traffic stop they fail to put the vehicle into park due other factors involved in the traffic stop causing the driver to be distracted. This results in further distractions and unnecessary vehicle collisions due to the driver not knowing that they put the vehicle transmission in the park position.

Prior art devices consist of automatic vehicle seat belt mechanisms and devices that are user controlled and/or involve the vehicle transmission to placed in the park position, the ignition to be turned off, and the key to be removed for the automatic seat belt release to be engaged. Other devices are designed for one time automatic releases to be engaged in the event of an accident.

Accordingly, there is a need for an automatic vehicle controlled safety belt system that allows the seat belt to be released when the vehicle transmission is put in a specified position allowing the driver or passenger of the vehicle one less thing to worry about and increase their effectiveness in situations where time is a crucial factor.

### BRIEF SUMMARY OF INVENTION

Summarily stated the present invention comprises of a vehicle safety belt release system that is designed to release a specified vehicle safety belt or belts when the vehicles transmission lever is put into a specific position.

The system shall include a control unit that will be connected to the entire system. The control unit will be able to turn the system on or off and be able to be set to control specified safety belts connected to the system. The control unit shall be connected to the vehicles transmission system. When the vehicles transmission is placed into the predetermined position a signal will be sent to the control unit that will activate the system and send an electric signal releasing the specified safety belts connected to the system that are set to be released through the control unit.

Furthermore the control unit shall be able to be connected to the vehicle electrical system and other devices that are controlled by the vehicles transmission including but not limited to siren and emergency light cut off devices.

The system further shall also include a power source. The power source shall originate from the vehicles electrical system. The power source shall be connected to the control unit, which shall provide power for the entire system. The said power source is designed so as not to interfere in any way with the vehicle.

The system further includes an electronic releasing mechanism built directly into the latching mechanism of a vehicle safety belt. The electronic releasing mechanism shall be connected to the control unit and will be controlled through said above control unit. The releasing mechanism will have a small electronically operated mechanism incorporated into the latching mechanism. The electric mechanism shall have a latch that when activated by the control unit shall release the secured vehicle safety belt. The latch and electronic mechanism is designed so that the person secured by the vehicle safety belt can also manually unlatch the vehicle safety belt if that person so desired. The device is designed for multiple automatic and manual releases.

### BRIEF DESCRIPTION OF THE SEVERAL VIEWS OF THE DRAWING

For a better understanding of the nature and objects of the present invention, reference should be made to the following detailed description with the accompanying drawings, in which:

FIG. 1 is a schematic diagram of an automatic vehicle-controlled safety belt release system, in accordance with the present invention;

FIG. 2 is an exemplary side view of the seat belt with electronic and manual release mechanism;

FIG. 3 is a flowchart representing the unbuckling process of the said invention when the vehicle transmission is put in a specific position.

### DETAILED DESCRIPTION OF THE INVENTION

The present invention will now be described more fully hereinafter with reference to the accompanying drawings, in which the preferred embodiment of the invention is shown. This invention may, however, be embodied in many different forms and should not be construed as limited to the embodiment set forth herein. Rather, this embodiment is provided so that this application will be thorough and complete, and will fully convey the true scope of the invention to those skilled in the art. Like numbers refer to like elements throughout the figures.

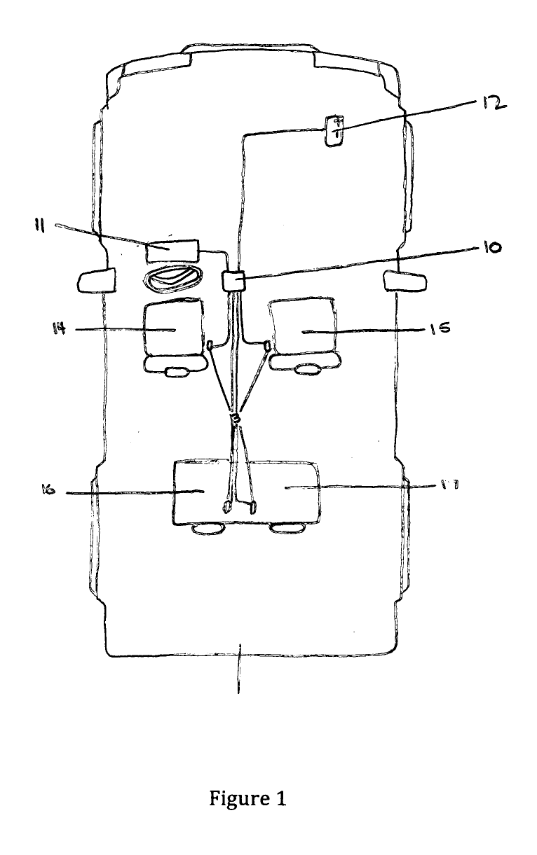

With reference to FIG. 1 the control unit 10 is connected to the vehicles transmission 11. For the purpose of this application the control unit 10 shall be set to engage the automatic seat belt system when the transmission 11 is placed in the “park” position. The control unit 10 is also connected to a power source 12 designed to come from the vehicles electrical system 12. Furthermore the control unit 10 shall be designed not to interfere in any way with the vehicles electrical system 12. The control unit 10 is also connected to the seat belt 13, which shall contain an electronic releasing mechanism 21.

The control unit 10 shall be able to be programmed so that the system can operate multiple automatic seat belts 13 including, but not limited to the driver 14, passenger 15, drivers rear seat passenger 16, and passenger side rear 17 seat belts 13. The control unit 10 will also be able to be turned on or off allowing a user to completely disable the system if they so choose. The control unit 10 shall be designed to be compatible with other vehicle transmission automated systems.

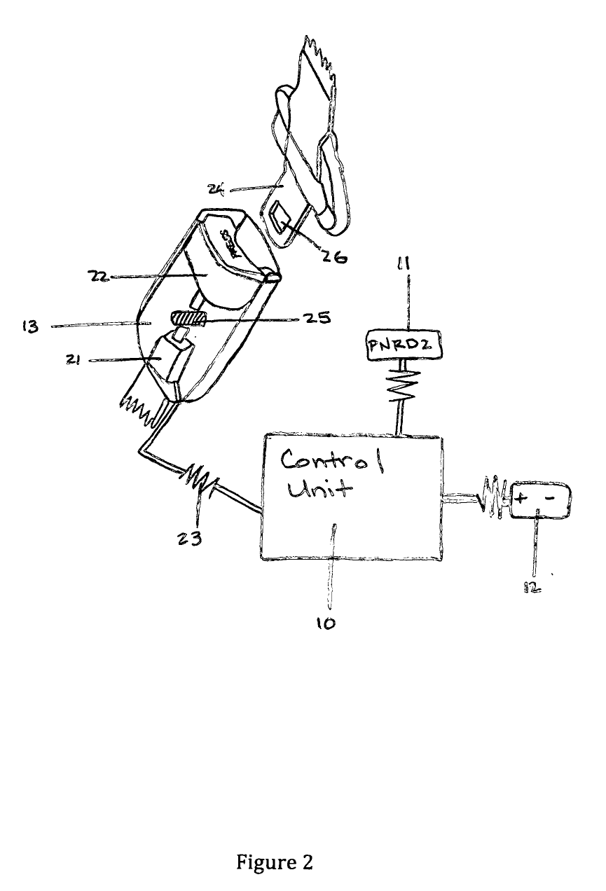

With reference to FIG. 2 the seat belt 13 shall include both a manual 22 and an automatic electrically operated releasing mechanism 21. The seat belt 13 shall be designed in such a manner that it will be able to be retrofitted into current vehicles along with new production models. The seat belt 13 shall include a manual release 22 so that when engaged a user may at any time release the seat belt 13. The automatic release mechanism 21 shall work with the manual release 22 and is designed so that when the control unit 10 sends the mechanism a release signal 23 the electric mechanism 21 will engage releasing the locking latch 25 from the tongue 24 automatically releasing the seat belt 13.

The seat belt 13 shall be attached to the vehicle or vehicle seat. The insertable tongue 24 of the seat belt 13 shall have a cut portion 26 so that when inserted into the seat belt 13 a locking latch 25 shall engage and lock the tongue 24 into the seat belt 13. The locking latch 25 will be designed to fit into the cut out portion 26 of the tongue 24. The automatic release 21 shall disengage the locking latch 25 from the tongue 24 allowing the tongue 24 to be removed from the seat belt 13. The manual release 22 shall disengage the locking latch 25 from the tongue 24 when engaged allowing the tongue 24 to be removed from the seat belt 13.

The seat belt 13 is designed in such a way that the electronic automatic release mechanism 21 and manual release mechanism 22 shall reset each time after being used so that the seat belt may be used multiple times as appropriate for daily use.

By providing a seat belt 13 with a manual release 22 the user has the option to release the seat belt 13 at his or her discretion and avoids any potential dangerous situations in which there is a failure in the automatic release system and the automatic release 21 fails to release the seat belt 13.

Further more by having an automatic seat belt release system operated by the vehicle simply by placing the transmission in a specific position, first responders who deal with life threatening situations will have one less thing to worry about and one less movement to make when responding to life and death situations and need to exit the vehicle as fast as possible.

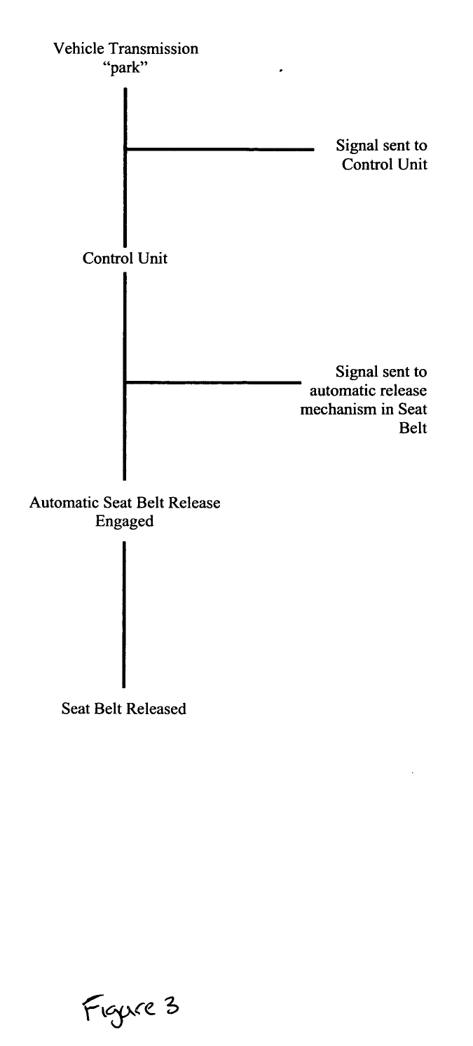

In FIG. 3 the operating procedure of the current invention is shown. For the purpose of this application the control unit shall be set to engage the automatic seat belt release system when the transmission is placed in the “park” position. When the transmission is placed into “park” a signal is sent to the control unit. The control unit sends a signal to the automatic releasing mechanism in the seat belt, which releases the latch and allowing the user to exit the vehicle knowing the vehicle transmission is in the preset position.

It should be understood that the system may be used to release many different types of safety belts and should not be limited to safety belts in emergency response vehicles.

What is claimed is:

1. An automatic seat belt release system that is automatically engaged when the vehicles transmission is put into a specific predetermined position releasing the seat belt. The said system shall comprise of:
a control unit that is connected to and operates the entire system:
the control unit shall be connected to the vehicles electrical system, vehicle transmission, and seat belt or seat belts that contain a manual and electronically operated releasing mechanism.
a seat belt containing an electronic and manual releasing mechanism.

2. The automatic seat belt release system of claim 1, wherein the control unit is able to be programmed to operate multiple automatic seat belt release mechanisms and be able to be turned on and off

3. The automatic seat belt release system of claim 1, wherein the control unit shall be powered by the vehicles electrical system. The control unit shall not interfere with operation of the vehicles electrical system.

4. The automatic seat belt release system of claim 1, wherein the control unit shall be connected to the vehicles transmission system and the control unit shall be able to be programmed so that the control unit will receive a signal from the vehicles transmission when the transmission is put into specific predetermined position.

5. The automatic seat belt release system of claim 1, wherein the control unit is connected to a seat belt that contains an electronic releasing mechanism and that the electronic releasing mechanism is operated by the control unit designed to automatically release the seat belt multiple times.

6. The automatic seat belt release system of claim 1, wherein the seat belt containing an electronic releasing mechanism shall also have a manual release designed to be able to release the seat belt manually multiple times.

7. The automatic seat belt release system of claim 1, wherein the seat belt electronic and manual release mechanism do not interfere with each other and both release the seat belt latch.

8. The automatic seat belt release system of claim 1, wherein the control unit shall be able to be programmed to recognize and receive signals from the vehicles transmission system when the transmission is put into a specific position.

9. The automatic seat belt release system of claim 1, wherein the seat belt is designed to have a locking latch that secures the receiving tongue into place and that the locking latch is able to be released from the receiving tongue by the electronic and manual releasing mechanism.
